(19) United States
(12) Patent Application Publication
(10) Pub. No.: US 2017/0350782 A1
(43) Pub. Date: Dec. 7, 2017

(54) FILL FLUID THERMAL EXPANSION COMPENSATION FOR PRESSURE SENSORS

(71) Applicant: Honeywell International Inc., Morris Plains, NJ (US)

(72) Inventors: Ronald E. Beselt, Burnaby (CA); Richard D. Daugert, Doylestown, PA (US); George E. Hershey, Blue Bell, PA (US)

(21) Appl. No.: 15/173,546

(22) Filed: Jun. 3, 2016

(51) Int. Cl. G01L 19/04; G01L 7/08

(52) U.S. Cl. CPC G01L 19/04; G01L 7/08

(57) ABSTRACT

A pressure sensor includes a housing with a cavity. The cavity includes a fill fluid and a compensation material. The fill fluid conveys a pressure from a process fluid through a diaphragm to a sensor. The compensation material reduces a difference of thermal expansions between the cavity and the fill fluid.

### TECHNICAL FIELD

This disclosure relates generally to pressure sensors. More specifically, this disclosure relates to a fill fluid with thermal expansion compensation for pressure sensors.

### BACKGROUND

Pressure sensors designed for process measurements of a process fluid typically utilize a fill fluid, which is an inert secondary fluid, to transmit pressure signals to relatively delicate internal sensing systems. The fill fluid is separated from process fluid by a flexible membrane typically in the form of a metallic diaphragm.

### SUMMARY

This disclosure provides a fill fluid thermal expansion compensation for differential pressure sensors.

In a first embodiment, a pressure sensor including a housing with a cavity is provided. The cavity includes a fill fluid and a compensation material. The fill fluid conveys a pressure from a process fluid through a diaphragm to a sensor. The compensation material reduces a difference of thermal expansion between the cavity and the fill fluid.

In a second embodiment, a system is provided. The system includes a control system and a pressure sensor. The control system is configured to communicate data with one or more pressure sensors. The pressure sensor includes a housing, a cavity, a compensation material and a fill fluid. The fill fluid conveys a pressure from a process fluid through a diaphragm to a sensor. The compensation material reduces a difference of thermal expansion between the cavity and the fill fluid.

In a third embodiment, a method thermal expansion compensation of a fill fluid in a pressure sensor is provided. The method includes reducing a difference of thermal expansions between a cavity and a fill fluid by using a compensation material inserted in the cavity. The method further includes conveying a pressure from a process fluid through the fill fluid, separated by a diaphragm, to a sensor.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial control and automation system according to this disclosure;

FIG. 2 illustrates an example differential pressure sensor according to this disclosure;

FIG. 3 illustrates another example differential pressure sensor according to this disclosure; and

FIG. 4 illustrates an example method for fluid fill thermal expansion compensation for pressure sensors according to this disclosure.

### DETAILED DESCRIPTION

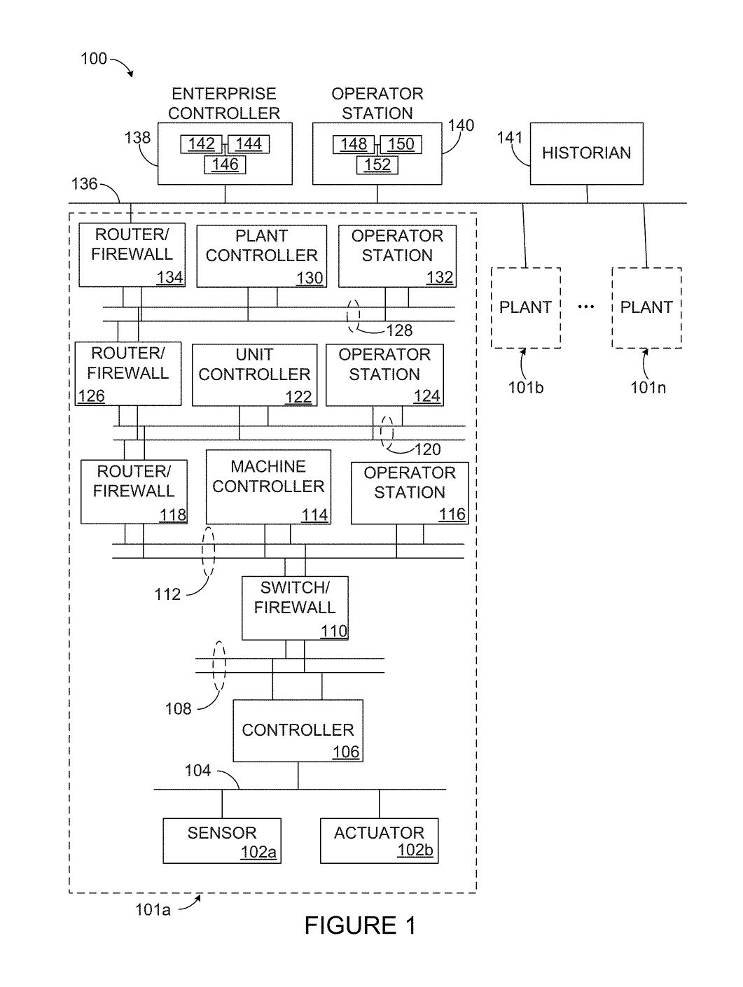

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any type of suitably arranged device or system.

Pressure sensors designed for measurements of a process fluid typically utilize a fill fluid, an inert secondary fluid, to transmit pressure signals to relatively delicate internal sensing systems. The disclosure describes how to reduce the effective thermal expansion of a fill fluid within a closed system to more closely match the expansion coefficient of the cavity of the housing such that extra volumetric loading of barrier diaphragms can be reduce over wide temperature ranges (e.g., −50° C. to 130° C.).

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, flow rate, or a voltage transmitted through a cable. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS (FF) network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Multiple controllers 106 could also operate in redundant configurations, such as when one controller 106 operates as a primary controller while another controller 106 operates as a backup controller (which synchronizes with the primary controller and can take over for the primary controller in the event of a fault with the primary controller). Each controller 106 includes any suitable structure for interacting with one or more sensors 102a and controlling one or more actuators 102b. Each controller 106 could, for example, represent a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as a pair of Ethernet networks or an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as a pair of Ethernet networks or an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers could include one or more processing devices 142 and one or more memories 144 for storing instructions and data used, generated, or collected by the processing device(s) 142. Each of the controllers could also include at least one network interface 146, such as one or more Ethernet interfaces or wireless transceivers. Also, each of the operator stations could include one or more processing devices 148 and one or more memories 150 for storing instructions and data used, generated, or collected by the processing device(s) 148. Each of the operator stations could also include at least one network interface 152, such as one or more Ethernet interfaces or wireless transceivers.

In accordance with this disclosure, various components of the system 100 support a process for fill fluid thermal expansion compensation for pressure sensors in the system 100. For example, one or more of the sensors 102a could include a pressure sensor that can compensate for thermal expansion over a wide temperature range, as described in greater detail below.

Although FIG. 1 illustrates one example of an industrial process control and automation system 100, various changes may be made to FIG. 1. For example, a control system could include any number of sensors, actuators, controllers, servers, operator stations, and networks. Also, the makeup and arrangement of the system 100 in FIG. 1 is for illustration only. Components could be added, omitted, combined, or placed in any other suitable configuration according to particular needs. Further, particular functions have been described as being performed by particular components of the system 100. This is for illustration only. In general, process control systems are highly configurable and can be configured in any suitable manner according to particular needs.

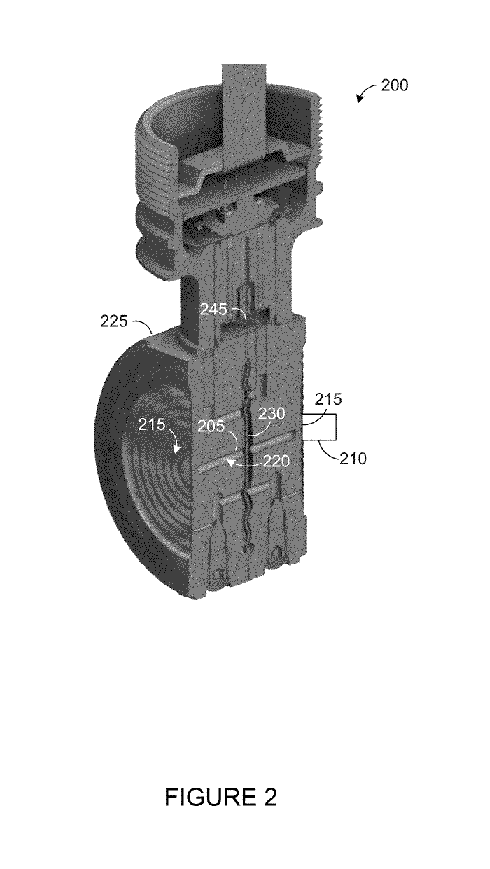

FIG. 2 illustrates an example differential pressure sensor 200 according to this disclosure. The embodiment of differential pressure sensor 200 illustrated in FIG. 2 is for illustration only. FIG. 2 does not limit the scope of this disclosure to any particular implementation. The pressure sensor 200 may represent (or be represented by) the sensor 102a of FIG. 1.

As shown in FIG. 2, the pressure sensor 200 is configured for mounting in a pipe containing a process fluid 210, such as oil or gas. The pressure sensor 200 measures the pressure of the process fluid 210 and transmits pressure readings to a system, such as the system 100. The process fluid 210 flowing through the pipe passes across a flexible membrane 215 exerting pressure on the flexible membrane. As shown in FIG. 2, a fill fluid 205 is separated from the process fluid 210 by a flexible membrane 215 typically in the form of a metallic diaphragm. The fill fluid 205 is an incompressible fluid, such as silicone oil. Because the fill fluid 205 is incompressible, when the process fluid 210 exerts pressure, that pressure is conveyed from the process fluid 210 through the flexible membrane 215 and the fill fluid 205 to a sensor 245. The fill fluid 205 works with the sensor 245 to measure the pressure from the process fluid 210. The cavity 220 in the housing 225 of the differential pressure sensor 200 that the fill fluid 205 is located in has a significantly lower thermal expansion coefficient than the fill fluid 205. As the differential pressure sensor 200 may be operated over a wide temperature range, relative shrinkage or expansion of the fill fluid 205 places extra stress on the barrier diaphragm 230 that must move to compensate for the volumetric changes. Since there is a practical lower limit to fill fluid 205 volumes, the volumetric changes caused by temperature place a lower limit on barrier diaphragm 230 size in a given design to keep the barrier diaphragm 230 stresses within acceptable limits. The barrier diaphragm 230 size constrains overall sensor size and cost due to material and manufacturing requirements.

Although FIG. 2 illustrates an example of a differential pressure sensor 200, various changes may be made to FIG. 2. For example, while a configuration of the components is illustrated in FIG. 2, other embodiments can include more or fewer components.

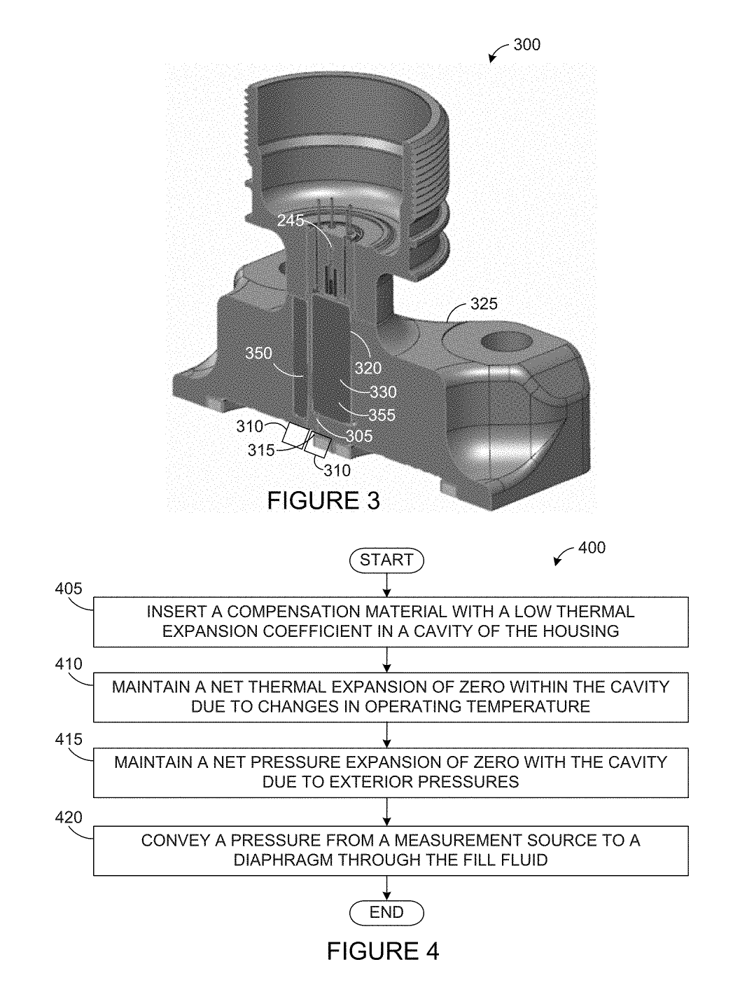

FIG. 3 illustrates another example differential pressure sensor 300 according to this disclosure. The embodiment of differential pressure sensor 300 illustrated in FIG. 3 is for illustration only. FIG. 3 does not limit the scope of this disclosure to any particular implementation.

The fill fluid 305 is separated from the process fluid 310 by a flexible membrane 315 typically in the form of a metallic diaphragm. The fill fluid 305 conveys a pressure from a process fluid 310 through a flexible membrane 315 to the sensor. The process fluid 310 works with a sensor 345 to measure the pressure from the process fluid 310. The cavity 320 in the housing 325 of the differential pressure sensor 300 that the fill fluid 305 is located in has a significantly lower thermal expansion coefficient than the fill fluid 305. A compensation material 330 is added to the cavity 320 to accommodate the difference in thermal expansion.

Construction of a compensation material 330 involves increasing the cavity 320 in a controlled manner that allows close fitting insertion of the compensation material 330 with a low or negative thermal expansion coefficient. The volume of low thermal expansion material is proportional to the fill fluid volume and the ratio of the fill fluid to enclosure expansion coefficients. For an enclosure constructed from stainless steel with a silicone fill fluid 305, the amount of low expansion material required would be about 20× the fill fluid volume.

As an example, the compensation material 330 can be manufactured as a cylindrical component of low expansion metal, such as a low expansion metal, ultra-low expansion glass or ceramic may be inserted into a close tolerance hole such that addition of extra fill fluid trapped within the gap between the two parts is minimized. During thermal expansion, the housing 325 will expand away from the compensation material 330 and produce a gap into which the fill fluid 305 can expand into rather than the diaphragm cavity. Ideally, the cylindrical shape of the compensation material 330 is advantageous since precise OD tolerances can be easily obtained by centerless grinding or lathe operations. The pocket can also be economically produced accurately by reaming operations. This close fit allows for a minimum of extra fill fluid 305 to be added to the system in the corners and gaps between the compensation material 330 and housing 325.

The differential pressure sensor 300 includes a low side sensor 350 and a high side sensor 355. The low side sensor 350 measures the pressure before a compressor. The high side sensor 355 measures the pressure after a compressor. Both the low side sensor 350 and the high side sensor 355 include a cavity where compensation material 330 can be inserted.

Although FIG. 3 illustrates an example of a differential pressure sensor 300, various changes may be made to FIG. 3. For example, while a configuration of the components is illustrated in FIG. 3, other embodiments can include more or fewer components.

FIG. 4 illustrates an example method 400 for fill fluid thermal expansion compensation for pressure sensors according to this disclosure. The process depicted in FIG. 4 is described as being performed in conjunction with the differential pressure sensor 300 illustrated in FIG. 3. Of course, this is merely one example; the process may be performed in conjunction with other sensors, such as the differential pressure sensor 200 of FIG. 2.

In operation 405, a compensation material 330 is inserted in a cavity 320 of a differential pressure sensor 300. The compensation material 330 is a material with a thermal expansion coefficient lower than a thermal expansion coefficient of the housing. In other embodiments, the compensation material 330 can also be chosen to reduce a difference for other reasons of change in volume, such as external pressure. The amount and shape of the compensation material 330 is determined based on the ratio compared to the fill fluid 305 in order for the changes in volume due to changes in temperature to not affect the pressure of the fill fluid 305. Increasing the pressure of the fill fluid 305 will increase the pressure on the barrier diaphragm resulting in inaccurate results or possible damage to the differential pressure sensor 300. The compensation material 330 is sized such that an average thermal expansion coefficient of both the volume of the fill fluid and the compensation material is less than the thermal expansion coefficient of the housing. A gap between the compensation material 330 and the housing 325 is minimized at a lowest operating temperature of the pressure sensor 300. The amount of the compensation material 330 and the amount of the fill fluid 305 has a net thermal expansion value that is zero or negative.

In operation 410, a net thermal expansion of zero is maintained within the cavity 320 for a range of operating temperatures. The range of operating temperatures is based on the temperature patterns at the location of the installation. The differential pressure sensor could be installed in a location where the operating temperature, for example, is in the temperature range from −50° C. to 130° C.

In operation 415, a net pressure expansion of zero is maintained within the cavity 320 due to exterior pressures. While a change in external pressure may not produce as great a difference in pressure within the cavity, any slight exterior pressure change could affect the reading of the pressure from the sensor. The compensation material 330 could balance any difference in pressure or volume between the fill fluid 305 and the housing 325 due to exterior pressure changes.

In operation 420, the fill fluid 305 conveys a pressure from a process fluid 310 to a diaphragm. The fill fluid 305 is an incompressible fluid to transmit the pressure from the process fluid 310 accurately. Due to the compensation material 330, the fill fluid 305 conveys an accurate reading at all operating temperatures.

Although FIG. 4 illustrates one example of a method 400 for fill fluid thermal expansion compensation for pressure sensors, various changes may be made to FIG. 4. For example, various steps shown in FIG. 4 could overlap, occur in parallel, occur in a different order, or occur any number of times.

It may be advantageous to set forth definitions of certain words and phrases used throughout this patent document. The terms “transmit,” “receive,” and “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A pressure sensor comprising:
a housing comprising a cavity, wherein the cavity contains:
a fill fluid configured to convey a pressure from a process fluid through a diaphragm to a sensor; and
a compensation material configured to reduce a difference of thermal expansion coefficients between the cavity and the fill fluid.

2. The pressure sensor of claim 1, wherein the thermal expansion coefficient of the compensation material is lower than the thermal expansion coefficient of the fill fluid.

3. The pressure sensor of claim 1, wherein a net thermal expansion value of the fill fluid and the compensation material is zero or negative.

4. The pressure sensor of claim 1, wherein the compensation material is further configured to reduce a difference of external pressure expansions between the cavity and the fill fluid.

5. The pressure sensor of claim 1, wherein the compensation material is further configured to reduce a difference in changes of thermal expansions for a temperature range from −50 degrees centigrade to 130 degrees centigrade.

6. The pressure sensor of claim 1, wherein the compensation material has a thermal expansion coefficient lower than a thermal expansion coefficient of the housing.

7. The pressure sensor of claim 6, wherein the compensation material is one of: a low expansion metal, an ultra-low expansion glass, or an ultra-low expansion ceramic.

8. A system comprising:
a control system configured to communicate data with one or more pressure sensors; and
a pressure sensor comprising:
a housing comprising a cavity, wherein the cavity contains:
a fill fluid configured to convey a pressure from a process fluid through a diaphragm to a sensor; and
a compensation material configured to reduce a difference of thermal expansion coefficients between the cavity and the fill fluid.

9. The system of claim 8, wherein the thermal expansion coefficient of the compensation material is lower than the thermal expansion coefficient of the fill fluid.

10. The system of claim 8, wherein a net thermal expansion value of the fill fluid and the compensation material is zero or negative.

11. The system of claim 8, wherein the compensation material further reduces a difference for changes in volume due to external pressure changes between the cavity and the fill fluid.

12. The system of claim 8, wherein the compensation material further reduces a difference in changes in volume due to thermal expansion for a temperature range from −50 degrees centigrade to 130 degrees centigrade.

13. The system of claim 8, wherein the compensation material has a thermal expansion coefficient lower than a thermal expansion coefficient of the housing.

14. The system of claim 13, wherein the compensation material is one of: a low expansion metal, an ultra-low expansion glass, or an ultra-low expansion ceramic.

15. A method comprising:
reducing a difference of thermal expansion coefficients between a cavity of a pressure sensor and a fill fluid by using a compensation material inserted in the cavity; and
conveying a pressure from a process fluid through the fill fluid, separated by a diaphragm, to a sensor.

16. The method of claim 15, wherein the thermal expansion coefficient of the compensation material is lower than the thermal expansion coefficient of the fill fluid.

17. The method of claim 15, wherein a net thermal expansion value of the fill fluid and the compensation material is zero or negative.

18. The method of claim 15, further comprising reducing a difference in changes in volume due to external pressure changes between the cavity and the fill fluid by using the compensation material.

19. The method of claim 15, further comprising reducing a difference in changes in volume due to thermal expansion for a temperature range from −50 degrees centigrade to 130 degrees centigrade.

20. The method of claim 15, wherein the compensation material has a thermal expansion coefficient lower than a thermal expansion coefficient of the housing.
